(19) United States
(12) Patent Application Publication
(10) Pub. No.: US 2004/0141885 A1
(43) Pub. Date: Jul. 22, 2004

(54) Pipettor systems and components

(75) Inventors: Charles N. Godin, Palo Alto, CA (US); Joseph H. Jackson III, El Granada, CA (US); Samuel A. Marquiss, Santa Clara, CA (US)

Correspondence Address: John J. McDonnell, McDonnell Boehnen Hulbert & Berghoff, 32nd Floor, 300 S. Wacker Drive, Chicago, IL, 60606, US

(73) Assignee: Molecular Devices Corp.

(21) Appl. No.: 10/725,074

(22) Filed: Dec. 1, 2003

Related U.S. Application Data
(63) Continuation-in-part of application No. 10/365,960, filed on Feb. 12, 2003.
(60) Provisional application No. 60/356,684, filed on Feb. 12, 2002.
(60) Provisional application No. 60/409,786, filed on Sep. 11, 2002.
(60) Provisional application No. 60/417,681, filed on Oct. 10, 2002.

(51) Int. Cl. B01L 3/02

(52) U.S. Cl. 422/100

(57) ABSTRACT

This invention relates to pipette systems for transferring fluid between fluid receptacles; dispensing fluid from a fluid reservoir to a fluid receptacle and the reverse; and systems capable of both transferring and dispensing fluids wherein the pipette system incorporates a flexible sealing element.

### CROSS REFERENCE TO RELATED APPLICATIONS

This application is a continuation in part of U.S. patent application Ser. No. 10/365,960, filed Feb. 12, 2003, which claims priority from U.S. Provisional Application Serial No. 60/356,684, filed Feb. 12, 2002, U.S. Provisional Application Serial No. 60/409,786, filed Sep. 11, 2002, and U.S. Provisional Application Serial No. 60/417,681, filed Oct. 10, 2002, the disclosure of each of which is incorporated herein by reference in its entirety.

This application hereby incorporates by reference in their entirety for all purposes the following patents and patent applications: U.S. Pat. No. 5,355,215, issued Oct. 11, 1994; U.S. Pat. No. 6,097,025, issued Aug. 1, 2000; U.S. patent application Ser. No. 09/478,819, filed Jan. 5, 2000; U.S. patent application Ser. No. 09/777,343, filed Feb. 5, 2001; U.S. patent application Ser. No. 10/061,416, filed Feb. 1, 2002; and U.S. patent application Ser. No. 09/703,472, now U.S. Pat. No. 6,550,349, filed Oct. 31, 2000.

### BACKGROUND OF THE INVENTION

1. Field of the Invention

This invention is in the field of fluid transfer systems. More particularly, the invention relates to single- or multi-channel pipettors useful for aspirating and/or dispensing of fluids.

2. Description of the Related Art

Pipettes are used for transferring precise amounts of a fluid from one container to another. A pipette is filled with the desired volume of fluid, by air displacement, positive displacement or capillary action, then the fluid is dispensed by positive or air displacement. Positive or air displacement are generally achieved with a plunger that slides within the barrel to the pipette. Commonly, a disposable plastic pipette tip is mounted on the pipette end to avoid having to clean or sterilize the remainder of the pipette. The pipette can be operated manually or by automated equipment.

Microplates are common containers for dispensed fluids in life science research. Microplates have multiple wells for fluid arranged in an array with, for example, 6, 24, 48, 96, 384, 864, or 1536 wells per plate. Most microplates conform to a standard footprint with well density increasing with increasing number of wells (e.g. 96-well plates have wells at a 9 mm spacing while 1536-well plates have wells at a 2.25 mm spacing). Liquid dispensing devices having a number of parallel pipettes have been developed to allow simultaneous operation of the pipettes for applications such as transferring fluid to and from microplates. Simultaneous pipetting is essential to such applications as initiating a reaction in every well of a microplate simultaneously. For such applications it is important to have a multichannel pipettor with the same number of channels as microplate wells. Even when it is not essential to the application, when using a lower number of pipettors than microplate wells, one must resort to multiple dispense (or aspirate) operations per plate leading to inefficient use of time. Just assembling conventional pipettors with the appropriate density is not enough to ensure a reliable simultaneous multichannel pipettor. Multichannel pipettors generally utilize individual plungers and seals and are not easily adaptable to higher density well format receptacles such as a 1536-well microplates because of size, reliability or both. Examples of prior art dispensing devices are described in U.S. Pat. Nos. 4,215,092 and 5,343,909. A need exists for a reliable pipetting system that can simultaneously transfer fluids to, from and/or between wells of higher density microplates.

In contrast to liquid transfer, as described above, dispensing of a liquid, such as a buffer solution, from a reservoir to a receptacle is often conducted using a needle through which the liquid from the reservoir (e.g., a syringe) is pumped into the receptacle. The same device often can be used for removing a liquid from the receptacle into the reservoir.

Transfer of a liquid between receptacles, therefore, requires different equipment from that used for dispensing of a liquid from a reservoir into a receptacle. Use of different equipment for transferring liquids and dispensing liquids is inefficient, especially when the transfer and dispensing are to the same receptacle. A need also exists, therefore, for devices that can be used for both liquid transfer and liquid dispensing.

In general, the accuracy of pipettors is limited at least in part by the ability of the barrel and plunger to form a seal. If the seal is poor, the system may lose vacuum or pressure, thereby altering the volume of fluid aspirated or dispensed. These alterations may lead to inaccuracies in the volume of a particular sample and inaccuracies and differences in the volumes of different samples, whether prepared by the same or different pipettors. The magnitude of the alterations may depend on the volume of fluid being transferred, for example, a larger volume of fluid may put larger stress on the seal, causing a larger loss of vacuum and a larger alteration in volume. These shortcomings may require different apparatus for different applications, or lead to missed hits, limited research capabilities, lower throughput, and/or increased costs for compounds, assays and reagents.

The accuracy problems caused by poor seals may be addressed by positioning a compliant element such as an O-ring or grease between the plunger and the barrel. Such an element forms a permanent sliding seal. However, compliant elements are only limited solutions because they may be sensitive to wear, variations in plunger and aperture sizes, and changes in temperature and/or materials, among others. Thus, a further need exists for new sealing aids that address one or more of these shortcomings, particularly for dispensing to multiple sample sites.

### BRIEF SUMMARY OF THE INVENTION

In one embodiment, this invention provides pipetting systems that can be used to transfer a controlled volume of fluid to, from, and/or between a plurality of wells of a microplate or other fluid reservoir or receptacle. The pipette system is particularly suitable for high-density microplates such as those with 1536 wells. The pipette system comprises: a displacement actuator; a flexible membrane; and a pipette tip array comprising one or more pipette tips, each pipette tip having an end for receiving a fluid, and a base for connection to the flexible membrane, wherein the flexible membrane is positioned between the displacement actuator and the pipette tip array and wherein the flexible membrane forms a static seal with the base of each pipette tip. The pipette tip array may optionally be individual elements, i.e., one tip for each aspirate/dispense location, or a single or group of elements that comprise multiple tips.

In another embodiment, this invention provides pipetting systems wherein a flexible membrane may form a part of the plunger or barrel interior thus providing an improved seal between the plunger and the barrel. In this embodiment, pressurized fluid or a vacuum within the plunger or barrel expands the membrane and reversibly forms a seal between the plunger and barrel. Thus, in this embodiment, the invention provides a pipette system for aspirating and/or dispensing small volumes of fluid. The pipette system comprises: a displacement actuator comprising one or more plungers; a pipette barrel through which the displacement actuator travels, a reversible seal element comprising a flexible membrane positioned on the plunger or in the barrel, and a pipette tip array comprising one or more pipette tips.

In further embodiments, the invention provides a multichannel pipette system for aspirating and/or dispensing fluid into multiple fluid receptacles comprising a pipettor having at least one body and two or more plungers; one or more removable pipette tip arrays, wherein the removable pipette tip arrays mate to the at least one body of the pipettor, and wherein each tip array has more than one tip. The invention also provides pipette arrays and sealing elements.

Yet further embodiments of the invention include pipetting systems wherein a reversible seal element formed of a flexible membrane allows the pipettor to dispense fluid from a reservoir to a receptacle such as a microplate, or the reverse, alleviating the need for separate liquid transfer and dispensing equipment. Fluid can be dispensed around the reversible seal element (when the seal is not engaged) or through a hollow pin or plunger. In this embodiment, the pipette system comprises: a displacement actuator comprising one or more hollow pins; a pipette barrel through which the displacement actuator travels; a reversible seal element positioned on the hollow pin or in the pipette barrel; a pipette tip array comprising one or more tips; a fluid flow channel connected to either the pipette barrel or hollow pin; and a valve to open or close the fluid flow channel.

### BRIEF DESCRIPTION OF THE DRAWINGS

FIG. 1 is a schematic diagram of an embodiment of a pipette system of the invention showing a displacement actuator, flexible membrane and a pipette tip array.

FIG. 2 is a schematic diagram showing a pipette tip array.

FIG. 3 is a schematic diagram showing a perspective view of a sealing element, in accordance with various aspects of the invention.

FIG. 4 is a schematic diagram showing a cross-sectional view of sealing element, in accordance with various aspects of the invention.

FIG. 5 is a cross-sectional schematic diagram showing a pipette tip in which the membrane is biased by a plunger of the displacement actuator.

FIG. 6 is a cross-sectional schematic diagram showing a pipette tip containing fluid.

FIG. 7 is a cross-sectional schematic diagram showing fluid being expelled from a pipette tip.

FIG. 8 shows a portion of a plunger having a reversible seal element, in accordance with aspects of the invention.

FIG. 9 shows a portion of a pipettor head assembly having a plunger with a reversible seal element, all in accordance with aspects of the invention.

FIG. 10 is a cross-sectional view of a pipette tip array, in accordance with aspects of the invention.

FIG. 11 is a cross-sectional view of a pipette system of the invention useful for both transfer of a liquid and dispensing of a liquid from a reservoir.

### DETAILED DESCRIPTION OF THE PREFERRED EMBODIMENT

This invention includes pipetting systems that can be used to simultaneously transfer a controlled volume of fluid to, from, and/or between the wells of a microplate or other fluid reservoir or receptacle. The pipette systems are particularly suitable for high-density microplates such as those with 1536 wells. The systems are simple, inexpensive to manufacture and reliable. The pipette systems can be used with manual and automatic pipettor devices. It is one of the advantages of the invention that the systems provide adjustable pipettors, i.e., pipettors capable of aspirating and dispensing varying amounts of fluids.

The system may include one or more pipettor channels. A pipettor channel, as used here, is an element suitable for dispensing to a single site. In some embodiments, each pipettor channel may include its own barrel, plunger, seal element, and/or pipette tip. In other embodiments, each pipettor channel may share one or more of these components with other pipettor channels.

The number and arrangement of pipettor channels may be determined by a number of factors, including pipetting strategy. For example, the pipettor may include a linear array of 8, 16, 32, or any other number of appropriately spaced pipettor channels to correspond to a single row of a 96-well, 384-well, 1536-well, or any other number of well microplate, respectively. In other non-limiting examples, the pipettor also may include a linear array of 12, 24 or 48 appropriately spaced pipettor channels to correspond to a single column of a 96-well or 384-well or 1536-well microplate, respectively. In further non-limiting examples, the pipettor may include square arrays of pipettor channels, such as arrays of 4, 16 etc, allowing a 384 channel pipettor to dispense into all wells of a 1536 well microplate (by moving channel A1 of the 384 channel pipettor four times to dispense into channels A1, A2, B1, and B2 of the 1536 well microplate), a 96 channel pipettor to dispense into all wells of a 1536 well microplate, and so on. The pipettor also may include a number and arrangement of pipettor channels to correspond to a portion of a row or column, or two or more rows or columns, or another type of sample holder. Pipettor head assemblies may be easily interchangeable on an appropriate driver to accommodate microplates and other sample holders with different numbers and/or densities of wells.

In an exemplary embodiment, the pipettor assembly is capable of pipetting (aspiration and dispense) small fluid volumes, less than about 20 microliters, within a 1536-well format, with speed and accuracy acceptable for high-throughput applications. Toward this end, the device overcomes inherent tolerance accumulation due to the large quantity of well locations. In other embodiments, the volumes pipetted may be less than about 500 microliters, 100 microliters, 50 microliters, 20 microliters, 10 microliters, 5 microliters, or 2 or fewer microliters, depending on the application. The spacing and movement of pipettor elements may be selected to facilitate interaction with a rack of pipette tips (or other dispense elements), for example, as described in the following U.S. patent application, which is incorporated herein by reference: Ser. No. 10/061,416, filed Feb. 1, 2002. In particular, the speed with which the pipette tips are loaded and/or the spacing between the pipettor elements may be selected to correspond to the number of and/or spacing between pipette tips in the rack.

Alternatively, or in addition, the spacing of pipettor elements may be adjustable, during operation, to facilitate interaction with a rack of pipette tips (or a sample holder), for example, by varying the relative pitch of the pipettor elements and dispense elements (or sample sites), as described in U.S. patent application Ser. No. 09/777,343, filed Feb. 5, 2001, which is incorporated herein by reference.

The dispense strategy for a multi-element pipettor assembly may be coordinated with a suitable detection strategy, including time-tagging or other strategies, for example, as described in the following U.S. patent applications, which are incorporated herein by reference: Ser. No. 09/777,343, filed Feb. 5, 2001; and Ser. No. 10/061,416, filed Feb. 1, 2002.

The pipette system may be capable of simultaneously and/or sequentially dispensing fluid in uniform and/or nonuniform aliquots at one or more sample sites. The system optionally may include additional components, such as (1) a loading and/or unloading system for loading and/or unloading pipette tips, respectively, (2) a thermal regulation system for controlling the temperature of the assembly and/or ancillary components, such as pipette tips and/or samples (e.g., to reduce bubble formation), (3) a driver system for moving the pipettor head assembly between aspirating and dispensing positions, and/or sample preparation and/or sample analysis positions, among others, (4) a processor for controlling aspiration and/or dispensing, and so on. More generally, the assemblies may include and/or interface with any element, apparatus, and/or sample holder described in the patents and patent applications listed above under Cross-References and incorporated herein by reference.

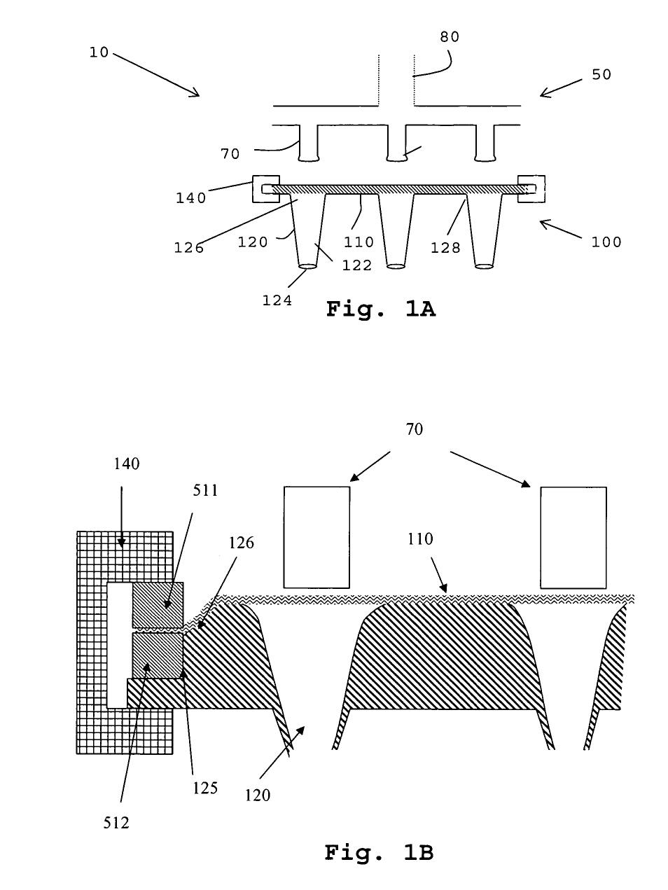

An embodiment of the pipette system of the invention is depicted in FIG. 1. Referring now to FIG. 1, a pipette system 10 comprises a displacement actuator 50, a pipette tip array 100, and a flexible membrane 110.

Displacement actuator 50 comprises one or more plungers 70 attached to a stem 80 for simultaneous control of all pipetting channels. In an optional embodiment, each plunger 70 may have its own stem 80 for individual control of pipetting channels.

Preferably, stem 80 and plunger 70 are formed of a unitary piece of rigid material. The rigid material can be a rigid plastic or metal. Suitable plastics include, but are not limited to, polypropylene, polystyrene and polyethylene. The tip 72 of each plunger 70 is preferably rounded to prevent puncture or excessive stretching of the flexible membrane 110 on the pipette tip array 100.

The displacement actuator 50 can be manually or automatically driven through stem 80 (not shown). Alternatively the displacement actuator 50 may comprise a fluid (e.g., hydraulic or air) that is pressurized to displace flexible membrane 110. In another alternative, displacement actuator 50 may comprise a vacuum to displace flexible membrane 110.

The pipette tip array 100 comprises one or more pipette tips 120. Each pipette tip 120 comprises a pipette tip body 122 defining an interior cavity and having an open end 124 for receiving a fluid, and a base 126 for sealing the flexible membrane 110. The pipette tip 120 is sealed at its base 126 to flexible membrane 110 in an essentially fluid tight relationship. When a plurality of pipette tips 120 are used, the tips can be formed as part of a single plastic piece, with the tips arranged in the desired configuration. Alternatively, the tips can be metal and formed as a metal tip array or inserted into a rigid holder in the desired configuration.

Flexible membrane 110 is an elastic material that can reversibly stretch when biased with plungers 70. Preferably, the flexible membrane 110 is essentially flat. Preferred materials for the flexible membrane 110 include gum rubber, neoprene, hypalon, silicone, santoprene, tygon, latex, norprene, and the like. Flexible membrane 110 is preferably a thin membrane with its thickness dependent upon the material used. For example membranes of latex have a preferred thickness of 25-250 μm, more preferably 75-125 μm.

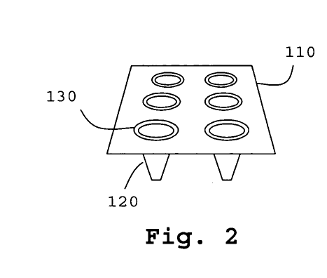

Each pipette tip 120 can be attached at its base 126 and form a seal with the flexible membrane 110 in a variety of ways. For example, pipette tip 120 can be attached to the membrane 110 by a clamp 140 or simply by the pressure of the displacement actuator 50 on the flexible membrane 110 over the base of the pipette tip. The combination of a clamp 140 and the pressure of the displacement actuator 50 can also be used. The attachment or connection can also be made using a sealing or bonding agent such as a glue or grease. A sealing agent, such as silicone oil, preferably Dow Corning 200 silicone fluid, can be applied to the surface of the membrane, to the base 126, or both, to improve the seal between the flexible membrane 110 and the base 126 of the pipette tip 120. The edge 128 of the base 126 of the pipette tip 120 can be raised to a smooth ridge to improve sealing by concentrating the downward pressure of the membrane onto base 126 of pipette tip 120. The attachment of pipette tip 120 to the membrane 110 can also be effected by using a sealing ring 130 or groove to secure flexible membrane 110 to base 126 of pipette tip 120, as depicted in FIG. 2. A sealing ring can also be used to secure the membrane to the base of groups of pipette tips. A groove in clamp 140 can be used as a mating feature for sealing ring 130, thus further improving sealing of membrane 110.

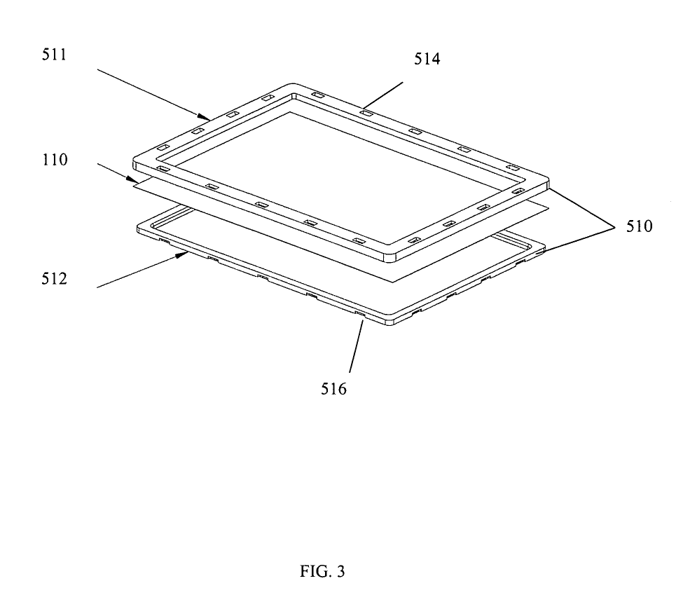

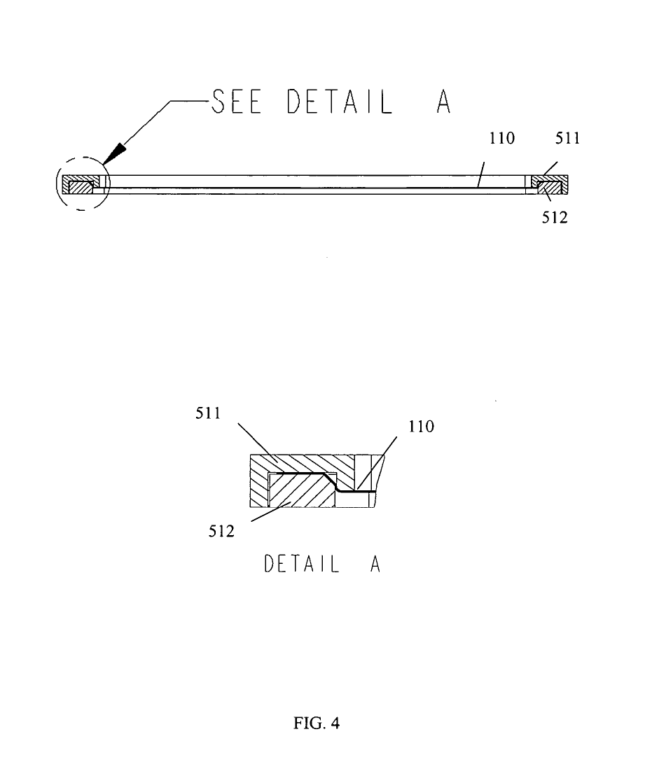

The flexible membrane can also be included in a separate sealing element. An example of such a sealing element is depicted in FIGS. 3 and 4. Referring now to FIGS. 3 and 4, the sealing element 500 includes one or more frames 510, having one of more open central regions, and including at least one flexible membrane 110 attached to the frames. Each open central region may be spanned by a different flexible membrane or one flexible membrane may span more than one open central region.

Frame 510 is preferably approximately of the same shape as the proximal end of the pipette tip array with which it is used. As one example, frame 510 can be a rectangular shape having outside dimensions of about 110-140 mm by about 75-100 mm (preferably about 120 mm by 85 mm), inside dimensions of about 100-120 mm by about 70-80 mm (preferably about 110 mm by 75 mm), and total thickness of about 1-5 mm (preferably about 3 mm). Frame 510 is made of a rigid material, such as plastic or metal, including molded plastic, cut plastic sheet, sheet metal, rigid foam sheet, rigid cut paper, cardboard or the like. The frame 510 is generally constructed of an upper frame 511 and a lower frame 512 with the flexible membrane 110 sandwiched in between.

The flexible membrane can be of any type described above. In a particularly preferred embodiment, the flexible membrane is a latex sheet of about 100 μm thickness. Flexible membrane 110 is attached to frame 510 so that the membrane does not exhibit wrinkles. Generally the flexible membrane is under slight tension. The membrane is attached to the frame using, for example, a glue or other bonding mechanism including ultrasonic welding and compression fit. The bonding agent can be located continuously around the perimeter of the membrane or at select locations. If a glue is used it may bond the membrane to the frame 510, the upper frame 511, the lower frame 512 or both the upper and lower frames. Additionally the upper and lower frames may be bonded together independent of the bond to the flexible membrane. The upper and lower frames may be bonded by glue or other bonding agent such as ultrasonic welding, compression fit etc.

In a preferred embodiment, the upper and lower frames are molded of plastic. Snap fit features may be included, comprising insertion tabs 514 along the upper frame 511, and receiving tabs 516 along the lower frame 512. As shown in FIGS. 3 and 4, frame 512 snaps into frame 511 such that flexible membrane 110 is sandwiched in between the two frames. The snap fit features allow upper frame 511, lower frame 512, and flexible membrane 110 to snap together as one unit.

The flexible membrane 110 can optionally include a sealing agent, such as oil or grease, on the surface that contacts the pipette tip array. One preferred sealing agent is silicone fluid, such as Dow Corning 200 fluid. The sealing agent facilitates the seal between membrane 110 and the pipette tip array.

The seal of the flexible membrane can also be improved with surface features on the pipette tip array such as a ridge or step 125 at the edge of the base 126 of the pipette tip 120 or pipette tip array (see FIG. 1(B)). Other surface features may be used in addition or in place of the foregoing such as a groove or raised ring 130 around the base 126 of the pipette tip 120 or pipette tip array (see FIG. 2). These surface features may be designed to mate with the flexible membrane frame 510 (e.g., the inner wall of the frame may closely fit a ridge that surrounds a pipette tip base). Further, the frame may also include its own surface feature at the edge, such as a ridge or step, that is complementary to the surface feature on the tip array. in addition, the surface features may be designed to mate with the clamping mechanism 140. For example, a groove in the clamp may closely fit a ring around a pipette tip base. With such an arrangement the flexible membrane is securely sandwiched within the surface features between the clamp and pipette tip array.

In another aspect of this invention, a plurality of pipette tips 120 are formed as a one piece pipette tip array. The unitary tip array can be a singe piece of plastic, or it can comprise a metal base having a plurality of holes and a plurality of tips attached to the metal base at the holes. If the unitary tip array is formed of difficult to clean materials such as most plastics, it is preferably a disposable item. Injection molding is one method to create plastic parts that are economical enough to be disposable.

In this aspect, flexible membrane 110 (with or without a frame) is positioned on base 126 of the tip array and sealed by a clamp 140 or simply the pressure of displacement actuator 50 pressing the membrane 110 over the base of the pipette tip, the seal being optionally aided by a sealing agent, preferably silicone oil. Alternatively membrane 110 is attached to the unitary tip array by gluing membrane 110 at base 126 of each pipette tip 120. Generally, the tips are arranged to be used with microplates, such as a 1536-well, 384-well, 96-well, 24-well or other density microplate. By way of examples, the tip array may contain a rectangular array of tips (48×32, 24×16, 12×8, etc.) corresponding to wells in a microplate, a square array (2×2, 4×4, 16×16, etc.) corresponding to wells in part of a microplate, or a linear array (8, 16, 32, 12, 24, 48, etc.) corresponding to rows or columns in a microplate.

In the above aspects of this invention, the displacement actuator 50 preferably comprises a plurality of plungers 70 arranged as an array. Plungers 70 are arranged in an array that matches the array of pipette tips and they may be arranged such that tip 72 of each plunger 70 is located adjacent to base 126 of each pipette tip 120, with flexible membrane 110 therebetween.

Displacement actuator 50 and pipette tip array 100 can be connected to each other by conventional methods. Such methods include, but are not limited to, a clamping mechanism.

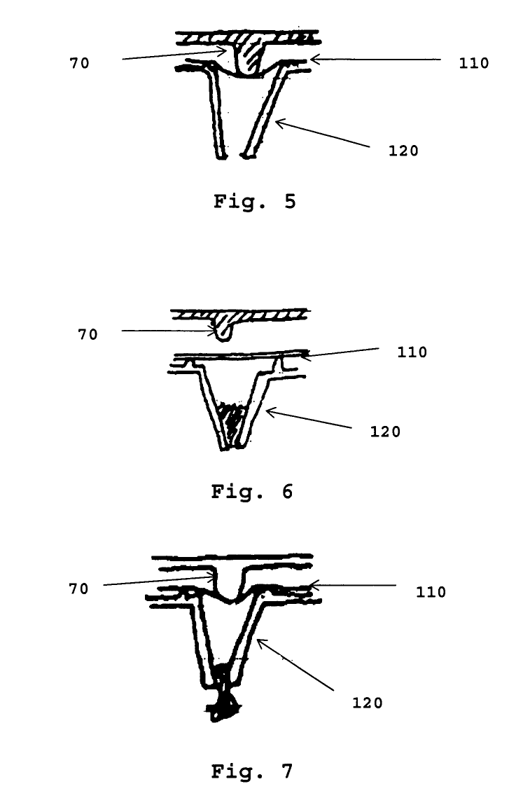

In operation, displacement actuator 50 is coupled to an automatic or manual pipettor device and the pipette tip array 100, with the flexible membrane positioned on the base of the array, connected to the displacement actuator 50. Activation of the displacement actuator 50 causes plunger 70 to bias flexible membrane 110 towards pipette tip 120, pushing air out of pipette tip 120, as shown in FIG. 5. Fluid is aspirated into the pipette tip by open end 124 of tip 120 below the level of a fluid in the well of a microplate or other fluid container. Moving displacement actuator 50 away from flexible membrane 110 causes membrane 110 to return to its relaxed position and thus pulls fluid into the pipette tip, as shown in FIG. 6. The fluid captured in the pipette tip is expelled into a receptacle, such as a microplate, by activating displacement actuator 50, which causes plunger 70 to bias flexible membrane 110 above pipette tip 120, expelling the fluid out of pipette tip 120, as shown in FIG. 7.

The pipette tip array 100 of the invention can be used with plungers other than the displacement actuator described above. For instance, a multitude of individually actuated plungers can be arrayed over the pipette tip array. With the addition of an appropriate mechanism, random access to any single well or combination of wells is possible. Furthermore the flexible membrane may be formed such that a negative pressure in the actuator is required to aspirate and a positive pressure is required to dispense.

In another embodiment of pipetting systems of the present invention, the flexible membrane is used as a reversible seal between the plunger and barrel. Thus, in this embodiment, the invention provides a pipettor system for aspirating and/or dispensing small volumes of fluid. The system generally comprises any mechanism for aspirating and/or dispensing fluid from, into, and/or onto a reservoir or other sample holder that employs the membrane as a reversible seal element to assist in the formation of vacuum and/or pressure used to aspirate or dispense fluid. The membrane may be part of the plunger or barrel interior. In this embodiment, pressurized fluid or a vacuum within the plunger or barrel expands (or contracts) the membrane and reversibly forms a seal between the plunger and barrel. The pipette system of this embodiment of the invention comprises: a displacement actuator comprising one or more plungers, a pipette barrel through which the displacement actuator travels, a reversible seal element that comprises a flexible membrane either on the plunger or in the barrel, and a pipette tip array comprising one or more tips.

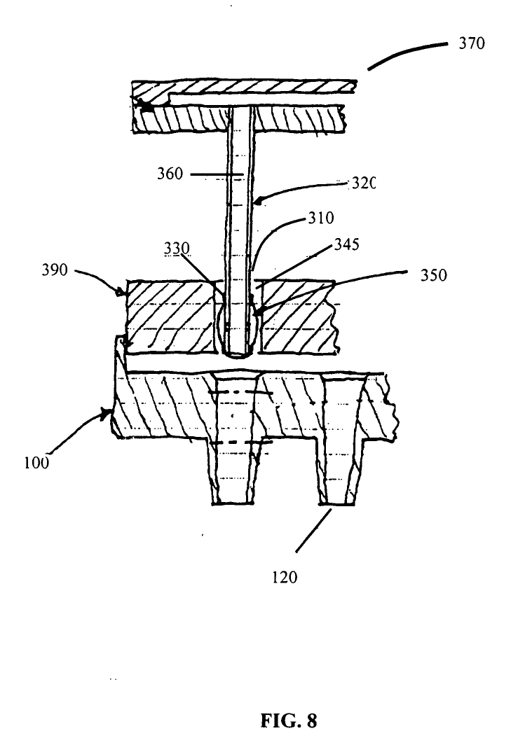

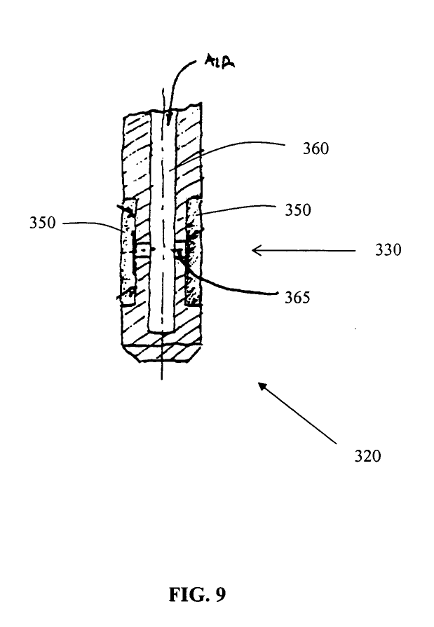

FIGS. 8 and 9 show portions of a pipettor system constructed in accordance with this embodiment of the invention. The system includes a barrel 310, a plunger 320, and a reversible seal element 330.

Barrel 310 generally comprises any void or volume in a suitable block or other support configured to receive plunger 320. In the embodiment of FIGS. 8 and 9, barrel 310 (or a part of the barrel) is at least substantially cylindrical, with a first end portion for receiving the plunger 320, a second end portion (directly or indirectly) connected to a pipette tip 100, and an interior portion 345 for engaging the seal element 330 such that vacuum or pressure may be created.

The plunger generally comprises any body configured to engage the barrel by sliding, so that relative movement of the barrel and plunger will create (or tend to create) vacuum and/or pressure for aspirating and/or dispensing fluid, respectively. In FIGS. 8 and 9, plunger 320 is at least substantially cylindrical; with an outer diameter that is slightly smaller than the inner diameter of the engaged portions of barrel 310.

Seal element 330 provides a reversible seal between barrel 310 and plunger 320 and comprises any mechanism for forming a seal between the barrel and plunger. Thus, seal element 330 may be used to initiate, terminate, and/or alter contact between barrel 310 and plunger 320. In particular, the alteration in contact may include an alteration in the extent (i.e., area) of contact, the geometry of contact, and/or the strength of contact, among others. Seal element 330 may be a portion of plunger 320, a portion of barrel 310, or a portion of both, depending on the embodiment. In the embodiment of FIGS. 8 and 9, seal mechanism 330 is a portion of plunger 320.

Seal element 330 typically functions through a change in volume, for example, by inflation and/or deflation of at least a portion of the seal element to increase and/or decrease, respectively, contact between the aperture and plunger 320. Typically, seal element 330 will include an adjustable portion having a volume that may be changed using any suitable mechanism, such as the application of vacuum and/or pressure, using any suitable medium, including air and/or fluid. In the embodiment of FIGS. 8 and 9, the volume of the adjustable portion is changed by a change in air pressure, in analogy with a balloon. Specifically, the adjustable portion includes a flexible member 350 such as rubber or a similar polymer bonded or molded onto plunger 320 such that a middle sealed circumferential region acts as a radial plenum that expands or contracts to adjust the extent of contact with aperture 310 upon a change in air pressure effected through channels inside the plunger 320. Air or vacuum is supplied through vent 370. In other aspects, a seal element can be similarly formed about the inside of barrel 310, such that it acts as a plenum that engages the plunger.

A reversible seal element, including a balloon-tipped plunger 320 as shown in FIGS. 8 and 9, may provide a number of advantages over O-rings and molded rubber plunger tips. In particular, the reversible seal element may maintain a more uniformly distributed seal over a large range of circumferential size tolerance and over a large number of tips/wells. Moreover, a reversible seal element may make syringe plunger alignment within the barrel cylinder less critical for sealing than with O-ring designs, and may even make the plunger somewhat self aligning.

The seal element may be selected and/or coated to affect or alter friction between the aperture and plunger. This friction should generally be high enough to promote a good seal but low enough so that the aperture and plunger may slide past one another, easily, reproducibly, and with minimal wear.

In the embodiment of FIG. 8, the pipettor assembly includes a molded single, multi-cavity tip array 100 that may be press mounted onto a head base 390. In use, the deflated ballooned tube/plenum assembly is lowered into position, the balloon is inflated, and the plunger then acts to create vacuum and/or pressure to aspirate and/or dispense, respectively. The balloon-tipped plunger may provide a high degree of compliance for sealing. Air or fluid for inflation is provided through vent 370.

In another embodiment, the invention provides a multichannel pipette system for aspirating or dispensing a fluid. The pipette system comprises a pipettor and one or more pipette tip arrays connected to the pipettor. Instead of or in addition to sealing with a flexible membrane the tip arrays may seal to the pipettor through a conventional engagement (cone, cone/ridge, etc.).

The pipettor can be any type of pipettor known in the art for dispensing fluids. Generally such a pipettor includes a housing or body and a plunger. The plunger slidably travels within the pipette body. The pipette body mates with a pipette tip to form a seal, allowing the plunger to displace air from the pipette tip so that a fluid can be aspirated.

In the invention, the pipettor includes one or more plungers. Each plunger may occupy it's own housing or body, or all the plungers may occupy the same housing or body. The pipettor may be manual or automated. If the pipettor is automated, it may be controlled by a computer. In a preferred embodiment, the pipettor is automatically alignable, for example using a computer, with the fluid receptacles to or from which fluid will be aspirated or dispensed.

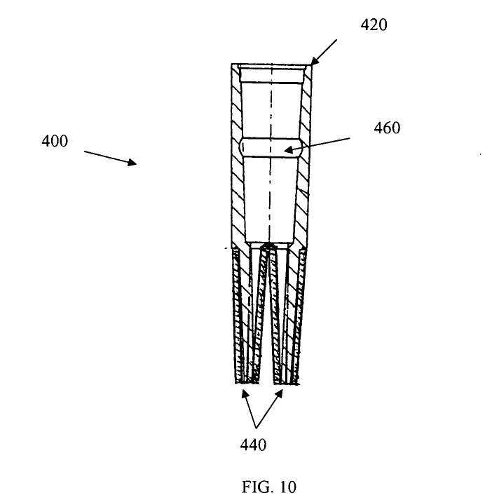

The multichannel pipettor includes at least one pipette tip array. One example of a pipette tip array is depicted in FIG. 10. Referring now to FIG. 10, the pipette tip array 400 includes a proximal end 420 for mating with the housing of a pipettor, and at least two pipette tips 440.

Proximal end 420 of pipette tip array 400 mates with the body of the pipettor to form a seal, allowing the plunger to displace or aspirate fluids to or from pipette tips 440. Preferably, each pipette tip array is acted on by one plunger. Thus, if the pipettor includes 4 plungers, four pipette tip arrays are used.

Pipette tip array 400 includes two or more pipette tips 440. Generally, the pipette tip array can include any number of pipette tips, with the number of pipette tips per pipette tip array and the number of pipette tip arrays being chosen according to the number of receptacles to and/or from which fluid will be transferred. For instance, if the pipettor is to be used to transfer fluids to or from a 1536 well microplate, the pipettor can include one tip array which includes 1536 tips in an array, or the pipettor can include four tip arrays each tip array including 384 pipette tips, or the pipettor can include 384 tip arrays, each element including 4 pipette tips, and so on. Any combination of pipette tips and pipette tip arrays can be used.

In preferred aspects, the pipette tips in pipette tip arrays 400 are arranged to be used with microplates, such as 1536-well, 384-well, 96-well, 24-well or other density microplates. The wells in a 1536-well microplate are usually spaced about 2.25 mm from center to center. In 384-well microplates the spacing of the wells is about 4.5 mm from center to center. When more than one pipette tip array is used with a single pipettor (e.g., 384 4-tip arrays) the tip to tip spacing should still be maintained even between tips from different pipettor tip arrays. To assist in maintaining the tip spacing the outside shape of the proximal end 420 is preferably square. In this way, if neighboring pipette tip arrays abutt when applied to the pipettor, they will also be aligned. Alternatively any exterior alignment feature known in the art may be used (e.g., flat surfaces, notches, keys, and so on.)

The seal between pipette tip array 400 and the body housing the plunger(s) can be made, for example, by including one or more ribs or wedges 460 inside pipette tip array 400. Examples of seals useable in the invention are described in U.S. Pat. No. 6,550,349, which is incorporated herein by reference in its entirety.

Alternatively, the seal can be made through the use of a flexible membrane. as described earlier in this application. The flexible membrane can be included as part of the pipette tip array, part of the pipettor, or can be an independent sealing element (for example, as shown in FIGS. 3 and 4).

When included as part of the pipette tip array, the flexible membrane is positioned over the proximal end of the pipette tip array. The flexible membrane is joined with the pipette tip array using techniques discussed above, and forms a static seal with the pipette tip array. In this aspect, each pipette tip array includes its own flexible membrane. Each flexible membrane is acted upon by one or more plungers (preferably one plunger for each tip of the array) of the pipettor to aspirate or dispense fluid to and/or from the pipette tips of the pipette tip array.

The multichannel pipettor of this embodiment of the invention provides several advantages over known systems. For instance, by including more than one pipette tip in a pipette tip array, fewer pipette tip arrays are needed for multiple well fluid transfers. As a result fewer plungers may be required for operating the pipette tips. For instance, only 384 pipette tip arrays that each include 4 pipette tips are required for transferring fluids to or from a 1536-well microplate. Consequently, fewer plungers are required for operating the tip array. In this example 384 pipette tip arrays can be used with readily available 384 channel pipettors to aspirate and dispense from 1536 microplates. Generally when a conventional seal is used, one plunger is required for each tip array. When a flexible membrane seal is used generally one plunger is required for each tip of the array.

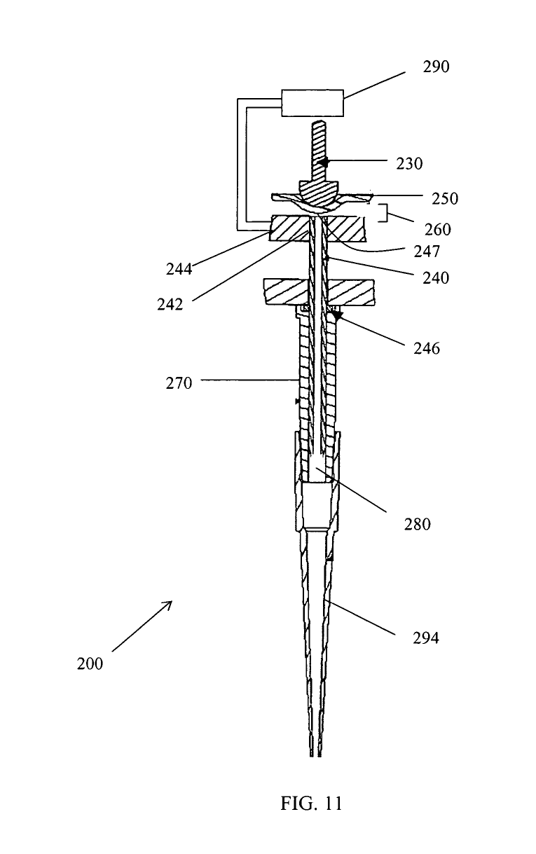

In a further embodiment of the invention, the reversible seal element can form part of a pipettor useful for dispensing a fluid from a reservoir to a receptacle, such as a microplate, or the reverse, thus alleviating the need for separate liquid transfer and dispensing equipment. Fluid can be dispensed around the reversible seal element (when the seal is not engaged) or through a hollow plunger or pin. In this embodiment, the pipette system comprises a displacement actuator comprising one or more hollow pins, a pipette barrel through which the displacement actuator travels, a reversible seal element, a pipette tip array that comprises one or more tips, a fluid flow channel connected to either the pipette barrel (opposite the tip array) or hollow pins, and a valve to open or close the fluid channel. Preferably, the reversible seal element is a flexible membrane located either on the hollow pin or in the barrel. Also preferably, the fluid flow channel is connected to the hollow pins. This embodiment of the pipette system of the invention is shown in FIG. 11.

Referring now to FIG. 11, the pipette system 200 shown comprises a plunger 230, a hollow pin 240, a flexible membrane 250, a fluid flow channel 260, and a pipette barrel 270 defining a piston chamber 280.

Hollow pin 240 is housed in piston chamber 280. Hollow pin 240 is open at both ends and can be made of various materials including metal, plastic or rubber. The upper end 242 of pin 240 is provided with a pin mounting plate 244. Pin 240, along with pin mounting plate 244, are axially movable within piston chamber 280. A sealing ring 246 is provided within piston chamber 280. Preferably, sealing ring 246 is an o-ring which provides an air-tight seal but other mechanisms such as lubricant or grease also can work. The upper portion of the pipettor (comprising elements 240, 244, 260, 250, 230, and 290) is moved relative to the lower portion by many possible mechanisms including manually (such as with a conventional pipetman), via linear stage (motor or manually actuated) or solenoid. If operated manually in the preferred manner, a return mechanism such as a spring (not shown) is used to bias the piston's position to one end of its travel. This biasing spring can be located in various places, such as between the mounting plate 244 and the top of the pipette barrel 270.

The hollow pin 240 is fluidically connected to a valve and fluid source or drain. The valve is preferably a flexible membrane 250 located between plunger 230 and the upper end 242 of the hollow pin 240. Membrane 250 can be made of various compliant materials including plastics rubbers, or latexes. Preferably membrane 250 is rubber.

A fluid flow channel 260 is defined by the upper end of the hollow pin 240 and plate 244 and the lower surface of membrane 250, as shown in FIG. 11. The fluid flow channel 260 is the connection point between the hollow pin 240 and various fluid dispensing or aspirating hardware, such as pumps, gas sources, valves or channels for introducing or removing fluid through the hollow pin 240.

When actuated, plunger 230 pushes membrane 250 onto top opening 247 of hollow pin 240. Plunger 230 can be actuated by an actuator 290, which may be mechanical or manual. Actuator 290 is rigidly connected to the hollow pin, for instance at the pin mounting plate 244 as shown in FIG. 11. When used for transferring fluids (discussed below) the plunger and its actuator are moved with hollow pin 240 to displace air within the pipette tip 294.

In one embodiment, actuator 290 is a solenoid device that causes the plunger to bias compliant membrane 250 onto top opening 247 of hollow pin 240, thereby sealing it—closing the valve. The pipettor functions as a transfer pipettor when the valve is closed.

In transfer pipettor operation, the membrane 250, the plunger 230, and the top of the hollow pin 240 together function as a valve to open and close the flow channel 260. Alternatively a valve could be located at the beginning of channel 260 instead of the end. When plunger 230 biases the membrane 250 and therefore blocks the opening of the hollow pin, i.e., the valve formed by the plunger and the membrane is closed, the pin acts as a piston. Thus, with the valve closed, the pipettor functions as a fluid transfer pipette, by aspirating and ejecting a fluid from the optional pipette tip 294. When the membrane 250 is not biased by the plunger 230, the valve formed by the plunger 230 and the membrane 250 is open. With the valve open, the pipettor functions as a fluid dispenser and any fluid, including liquid or gas, that is pumped through the flow channel will flow through the hollow pin and out of the optional pipette tip 294. Thus, when the valve is open, the pipettor can be used to dispense fluids, including reagents, from, for example, a fluid reservoir. If suction is applied to the flow channel, fluid flows through the hollow pin into the flow channel.

The pipette system of this embodiment of the invention can be used for several functions. For instance, when the valve formed by the plunger and the membrane is open, the pipettor can be used as a dispenser, with or without a pipette tip, allowing for example, repetitive dispensing of a reagent from a large reservoir. Similarly, wash solution can be dispensed through the tip when the valve is open. In fact, more than one wash solution can be used by appropriate selection of an upstream valve. Further, with the valve open, wash solution can be aspirated through the tip or dry and/or heated air can be used to dry the tip and the interior of the pipette. With the valve closed, the device can be used as a transfer pipettor, by moving the hollow pin and the plunger/membrane valve up and down together relative to the barrel.

The various embodiments of pipette systems described herein can be used independently of or in conjunction with each other.

The invention has been described with reference to various specific and preferred embodiments and techniques. However, it should be understood that many variations and modifications may be made while remaining within the spirit and scope of the invention.

What is claimed is:

1. A multichannel pipette system for aspirating and/or dispensing fluid into multiple fluid receptacles comprising:
a pipettor having at least one body and two or more plungers;
one or more removable pipette tip arrays, wherein the removable pipette tip arrays mate to the at least one body of the pipettor, and wherein each tip array has more than one tip.

2. The multichannel pipette system of claim I wherein the pipettor is an automated pipettor.

3. The multichannel pipette system of claim 1 wherein the more than one tips are automatically aligned with the fluid receptacles.

4. The multichannel pipette system of claim 1 wherein the multiple fluid receptacles are within a multiwell plate.

5. The multichannel pipette system of claim 1 wherein the removable tip arrays comprise four tips or sixteen tips in a square array, the array corresponding to wells in a microplate.

6. The multichannel pipette system of claim 1 wherein the removable tip arrays comprise 1536, 384, 96, 24, 12, or 6 tips in a rectangular array, the array corresponding to wells in a microplate.

7. The multichannel pipette system of claim 1 wherein the removable tip arrays comprise 48, 32, 24, 16, 12, or 8 tips in a linear, the array corresponding to wells, rows or columns in a microplate.

8. The multichannel pipette system of claim 1 comprising an equal number of bodies, plungers, and tip arrays, with one plunger traveling in each body.

9. The multichannel pipette system of claim 8 wherein each tip array mates to a body.

10. The multichannel pipette system of claim 1 wherein the tip arrays each further comprise a flexible membrane, the membrane forming a static seal with the tip array.

11. The multichannel pipette system of claim 1 further comprising a flexible membrane positioned between the tip arrays and the plungers, the membrane forming a static seal with the tip arrays.

12. The multichannel pipette system of claim 11 wherein the flexible membrane is connected to the pipettor by one or more clamps.

13. The multichannel pipette system of claim 11 wherein the static seal between the flexible membrane and the tip arrays is formed in part with a sealing fluid.

14. The multichannel pipette system of claim 11 wherein the flexible membrane is held by a frame, the frame having a center region, and the flexible membrane spans the center region of the frame.

15. The multichannel pipette system of claim 1 wherein the tip arrays are formed of plastic, metal or combinations thereof.

16. The multichannel pipette system of claim 14 wherein each tip array includes a mating feature at its edge for mating with the frame.

17. A sealing element for forming a seal between a pipettor and tip arrays of a multichannel pipettor comprising:
a frame having a center region; and
a flexible membrane attached to the frame, such that the membrane covers the center region of the first frame.

18. The sealing element of claim 17 wherein the frame comprises a top frame and a bottom frame, and wherein the flexible membrane is sandwiched between the top frame and the bottom frame.

19. The sealing element of claim 17 wherein a sealing fluid covers at least a portion of the side of the flexible membrane that seals with the pipette tip array.

20. The sealing element of claim 17 wherein the frame is rectangular, and the flexible membrane and the frame are of essentially the same width and length.

21. The sealing element of claim 17 wherein the flexible membrane is a latex sheet.

22. The sealing element of claim 18 wherein the frame includes a surface feature that assists the alignment or joining of the frame to the pipette tip array.

23. A pipette tip array for use with a multichannel pipettor to aspirate and/or dispense fluid into multiple fluid receptacles comprising a plurality of pipette tips.

24. The pipette tip array of claim 23 wherein the plurality of pipette tips are configured in a square, rectangular or linear array.

25. The pipette tip array of claim 24 comprising 1536, 384, 96, 24, 12, or 6 tips in a rectangular array, the tips in the array corresponding to receptacles in a microplate.

26. The pipette tip array of claim 24 comprising four or sixteen tips in a square array, the tips in the array corresponding to receptacles in a microplate.

27. The pipette tip array of claim 24 comprising 48, 32, 24, 16, 12, or 8 tips in a linear array, the tips in the array corresponding to receptacles in a microplate.

28. The pipette tip array of claim 23 wherein the multiple fluid receptacles are in a microplate and the plurality of pipette tips are arranged to correspond to the receptacle locations.

29. The pipette tip array of claim 23 further comprising a flexible membrane attached to the pipette tip array.

30. The pipette tip array of claim 29 wherein the flexible membrane forms a seal with the pipette tip array with a sealing fluid.

31. The pipette tip array of claim 29 wherein the flexible membrane is positioned in a frame, and wherein the frame includes a surface feature that assists the alignment or joining of the frame to the pipette tip array.
